(19) United States
(12) Patent Application Publication
(10) Pub. No.: US 2025/0238610 A1
(43) Pub. Date: Jul. 24, 2025

(54) METHODS AND SYSTEMS FOR MODEL GENERATION AND INSTANTIATION OF OPTIMIZATION MODELS FROM MARKUP DOCUMENTS

(71) Applicant: HUAWEI CLOUD COMPUTING TECHNOLOGIES CO., LTD., Gui'an New District (CN)

(72) Inventors: Rindranirina RAMAMONJISON, Kanata (CA); Timothy Tin Long YU, Kanata (CA); Haley LI, Kanata (CA); Kun MAO, Shenzhen (CA); Zirui ZHOU, Kanata (CA); Yong ZHANG, Kanata (CA)

(21) Appl. No.: 19/174,609

(22) Filed: Apr. 9, 2025

Related U.S. Application Data
(63) Continuation of application No. PCT/CN2022/129233, filed on Nov. 2, 2022.

(51) Int. Cl. G06F 40/221; G06F 40/111; G06F 40/166; G06F 40/295; G06F 40/30

(52) U.S. Cl. CPC G06F 40/221; G06F 40/111; G06F 40/166; G06F 40/295; G06F 40/30

(57) ABSTRACT

Methods and systems for generating a symbolic model from a markup document, and instantiating a model instance from a symbolic model are described. A markup document containing human language content and mathematical content is parsed into a symbolic model that contains only symbolic code representing an optimization problem. The markup document is parsed to extract a markup declaration, the markup declaration is then processed to a math content span, any metadata entity and any relationship between any metadata entity and the math content span. The math content span is processed into a math content parse tree. The math content parse tree is converted into symbolic code of the symbolic model using any relationship between the metadata entity and the math content span. The symbolic model can be instantiated using data definitions.

### CROSS-REFERENCE TO RELATED APPLICATIONS

The present disclosure is a continuation of PCT Application No. PCT/CN2022/129233, filed on Nov. 2, 2022, entitled “METHODS AND SYSTEMS FOR MODEL GENERATION AND INSTANTIATION OF OPTIMIZATION MODELS FROM MARKUP DOCUMENTS”, the disclosure of which is hereby incorporated by reference in its entirety.

### TECHNICAL FIELD

The present disclosure relates to methods and systems for parsing a markup document to automatically generate computer code representing a model instance, where the model instance can be inputted to an optimization solver to solve an optimization problem.

### BACKGROUND

Many real-world problems are optimization problems, such as how to minimize usage of a limited resource or how to maximize throughput of a system. In many cases, these optimization problems are complex (e.g., having many different constraints, many different conditions, many different variables, etc.) and cannot be practically solved by humans. Optimization solvers (also simply referred to as “solvers”) are software tools that have been developed to solve such optimization problems.

A conventional process for solving an optimization problem involves a human expert creating a markup document that formulates the optimization objective(s), constraints, etc. The markup document involves the use of both natural language (i.e., human-understandable textual content) as well as mathematical formulas. The markup document is then converted, by another human expert (e.g., an operations research (OR) expert), into an optimization model and the model is instantiated into a model instance using actual numerical data. The model instance is in the form of computer-readable code that can be inputted to the solver. If the optimization problem is adjusted (e.g., by the addition or deletion of a constraint), the OR expert must make corresponding changes to the code of the model and model instance. Similarly, if a new model instance is needed (e.g., when new data becomes available), the OR expert must generate the code for a new model instance. This process can be inefficient, both in time and resources. The need for an

[symbol]

OR expert also limits the practical use of solvers since the OR expert can become a bottleneck.

It would be useful to provide a solution that can improve the accessibility of solvers and/or improve the efficiency in solving optimization problems.

### SUMMARY

In various examples, the present disclosure describes methods and systems for generating a symbolic model from a markup document describing an optimization problem, which may be an unstructured, multimodal markup document. The present disclosure also describes methods and systems for instantiating the symbolic model into a model instance, which can be inputted to a solver to solve the optimization problem. The disclosed methods and systems enable a markup document to be converted into a model instance that can be inputted to a solver, without requiring the expertise of a human OR expert.

In some examples, the present disclosure describes the generation of symbolic models, which can be stored in a symbolic model database. This provides the technical advantage that model instantiation can be efficiently performed by retrieving an already-generated symbolic model from the database and instantiating the model using data values, without having to generate the model each time. Further, examples of the present disclosure enable the semantic meaning of each symbolic model to be stored in the symbolic model database, which provides the advantage that the symbolic model database can be directly searched to retrieve a desired symbolic model.

Examples of the present disclosure may be capable of generating model instances for a variety of solvers (which may have different configurations), without requiring a human expert to manually code each model instance according to the requirements of each solver. This provides better flexibility and scalability, and improved efficiency.

Examples of the present disclosure may enable the generation of a symbolic model to be decoupled from instantiation of the model instance. This may provide the technical advantage that different model instances can be instantiated, to suit different data definitions and/or different solvers, without having to generate a new symbolic model each time. This may simplify the process of updating data, adapting to a new solver, debugging code or exploring different data scenarios.

In an example aspect, the present disclosure describes a method including: receiving a markup document representing an optimization problem the markup document containing human language content and mathematical content; parsing the markup document into a symbolic model containing only symbolic code representing the optimization problem by: extracting at least one markup declaration from the markup document; for the at least one markup declaration, extracting at least one respective math content span, and extracting any respective metadata entity and any relationship between the at least one respective math content span and any respective metadata entity; for the at least one math content entity, generating a respective math content parse tree; and converting the respective math content parse tree to symbolic code using any relationship between the at least one respective math content span and any respective metadata entity, the symbolic code forming the symbolic model; the method also includes outputting the symbolic model associated with semantic metadata containing the at least one respective metadata entity.

In an example of the preceding example aspect of the method, the method may also include: implementing a declaration extractor, using a first trained neural network, to extract the at least one markup declaration from the markup document; and implementing a named entity recognition and relation extractor, using a second trained neural network, to extract the at least one respective math content span, any respective metadata entity and any relationship between the at least one respective math content span and any respective metadata entity.

In an example of the preceding example aspect of the method, the first trained neural network and the second trained neural network may each be based on a pre-trained natural language processing neural network.

In an example of any of the preceding example aspects of the method, the method may also include: providing a user interface for receiving the markup document and for displaying at least one symbolic parameter of the symbolic model, the at least one symbolic parameter corresponding to the at least one math content span, the at least one symbolic parameter being displayed with any related respective metadata entity.

In an example of the preceding example aspect of the method, the method may also include: receiving input to edit the at least one symbolic parameter.

In an example of any of the preceding example aspects of the method, the symbolic model associated with the semantic metadata may be stored in a symbolic model database.

In an example of any of the preceding example aspects of the method, the method may also include: obtaining at least one data definition; generating at least one data definition mapping that maps the at least one data definition to at least one symbolic parameter of the symbolic model; processing the symbolic model, using the at least one data definition mapping and the at least one data definition, to generate a model instance; and outputting the model instance to be solved by a solver.

In an example of the preceding example aspect of the method, the method may also include: obtaining a solver configuration; where the model instance may be generated according to the solver configuration.

In an example of some of the preceding example aspects of the method, the method may also include: identifying a discrepancy between the at least one data definition and the at least one symbolic parameter; and outputting a notification indicating the discrepancy.

In an example of some of the preceding example aspects of the method, the symbolic model may be stored in a database, and the method may also include retrieving the symbolic model from the database in response to a query.

In some example aspects, the present disclosure describes a computing system including a processing unit configured to execute computer-readable instructions to cause the system to perform the method of any one of the preceding example aspects of the method.

In another example aspect, the present disclosure describes a non-transitory computer readable medium having machine-executable instructions stored thereon, where the instructions, when executed by a processing unit of an apparatus, cause the apparatus to perform the method of any one of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram of a simplified example system that may be used to generate a symbolic model and instantiate a model instance, in accordance with examples of the present disclosure;

FIG. 2 is a block diagram of an example computing system that may be used to implement examples of the present disclosure;

FIG. 3A is a block diagram illustrating components of an example symbolic model generator, which may be used in the system of FIG. 1, in accordance with examples of the present disclosure;

FIGS. 3B-3D illustrate example annotated training data that may be used to train a neural network of the symbolic model generator of FIG. 3A, in accordance with examples of the present disclosure;

FIG. 3E is a block diagram illustrating components of an example named entity recognition and relation extractor, which may be used in the symbolic model generator of FIG. 3A, in accordance with examples of the present disclosure;

FIG. 3F illustrates an example math content parse tree, which may be generated by a subsystem of the symbolic model generator of FIG. 3A, in accordance with examples of the present disclosure;

FIG. 4 illustrates an example of how the symbolic model generator of FIG. 3A may process a markup document into a symbolic model, in accordance with examples of the present disclosure;

FIG. 5 illustrates an example user interface that may be provided by the system of FIG. 1, in accordance with examples of the present disclosure;

FIG. 6 is a block diagram illustrating components of an example model instantiator, which may be used in the system of FIG. 1, in accordance with examples of the present disclosure;

FIG. 7 is a flowchart illustrating an example method for generating a symbolic model from a markup document, in accordance with examples of the present disclosure; and

FIG. 8 is a flowchart illustrating an example method for instantiating a model instance from a symbolic model, in accordance with examples of the present disclosure.

Similar reference numerals may have been used in different figures to denote similar components.

### DETAILED DESCRIPTION

To assist in understanding the present disclosure, some background discussion of optimization problems and solvers is first provided.

An optimization problem is often described mathematically by a domain expert in the format of a markup document. The domain expert may use math symbols to represent decision variables (e.g., the unknown variables to be solved) and data parameters (e.g., the parameters whose values can be populated with real-world data), and may use math formulas to define the optimization objective (e.g., the function to be maximized or minimized) and applicable constraints (e.g., inequality and/or equality constraints). Human-understandable text, such as English language text, are used to define the meaning of the symbols and formulas in the context of the optimization problem. A markup document may also be referred to as a multimodal document, as it involves both human-understandable text and computer-readable symbols (or “markups”). Some common markup languages for creating markup documents include Markdown, TeX, LaTeX, MathML and OpenMath, among others. Each markup language defines certain syntax and symbols that the domain expert can use to intersperse math content with natural language content.

For the optimization problem to be understandable and solvable by an optimization solver (referred to hereafter as simply “solver” or “software solver”), the markup document must be converted to computer-readable code. This involves the skill of an operations research (OR) expert to convert the markup document into a symbolic model and then to instantiate the model. The symbolic model is a symbolic and context-free representation of the optimization problem that is coded using a computing programming language or modeling language. The optimization problem may have one or more objectives, and one or more constraints. In many optimization problems, there is one objective and multiple constraints, though in other optimization problems there may be multiple objectives and/or a single constraint. The present disclosure may make reference to “objective” in the singular and “constraints” in the plural, however the use of singular or plural is not intended to be limiting. The symbolic model may contain the mathematical objective and constraints of the optimization problem, represented as mathematical functions of symbols representing the data parameters and decision variables. The symbolic model may omit the semantic meaning of the mathematical symbols and formulas, such that the actual real-world relevance of the symbols and formulas may not be readily apparent from the symbolic model alone.

Notably, the symbolic model does not contain actual data values. The process of importing data into the symbolic model may be referred to as model instantiation. Model instantiation is a task that is typically performed by the OR expert. When the data parameters of the symbolic model are given actual data values (e.g., from a real-world scenario), the symbolic model is instantiated and a model instance is created, which is a specific instance of the symbolic model in the form of computer-readable code that can be inputted to a solver to generate a solution to the optimization problem. There are various solvers that can be used to solve different optimization problems and each solver may require different specific structured inputs (e.g., specific keywords, specific order of code, etc.) to be provided by the model instance.

Accordingly, the skills of an OR expert are important to convert the optimization from a human-understandable language (e.g., as represented by the markup document) to a computer-readable code (e.g., the model instance). Furthermore, because the symbolic model instance is stripped of semantic meaning, the symbolic model and model instance may be difficult to be understand by a human who is not an OR expert. Accordingly, it can be difficult for a domain expert to verify whether the optimization problem has been accurately represented in the symbolic model or the machine instance. As well, it can be difficult for a domain expert to make even slight changes to the optimization problem without help from an OR expert.

Some attempts have been made to simplify this process, but no solution to date has been able to successfully convert a markup document to a model instance without extensive human input. For example, some existing approaches are able to generate model instances only when provided with input that is structured in a very specific and limiting way (e.g., must contain only mathematical content, must use specific keywords, or must define the optimization problem in a specific order). The result is that the process is still inefficient and still requires some OR expertise to manually process or structure the markup document. Furthermore, some existing approaches generate a model instance directly from the markup document and data definitions, without an intermediate step of generating a symbolic model. This means that if the data definitions change (e.g., there is more up-to-date real-world data to be inputted to the model instance), the markup document will need to be reprocessed from scratch.

In various examples, the present disclosure describes methods and systems that enable conversion of unstructured technical documents (e.g., markup documents) containing both natural language text and mathematical content into a model instance that can be inputted to a solver. In particular, the present disclosure describes methods and systems that generate a symbolic model from a markup document, as intermediate steps. The symbolic model may be stored for future use, and may be more easily processed into a new model instance to adapt to new data definitions or changes to the model constraints or objectives, for example, compared to existing approaches that generate a model instance directly from the markup document.

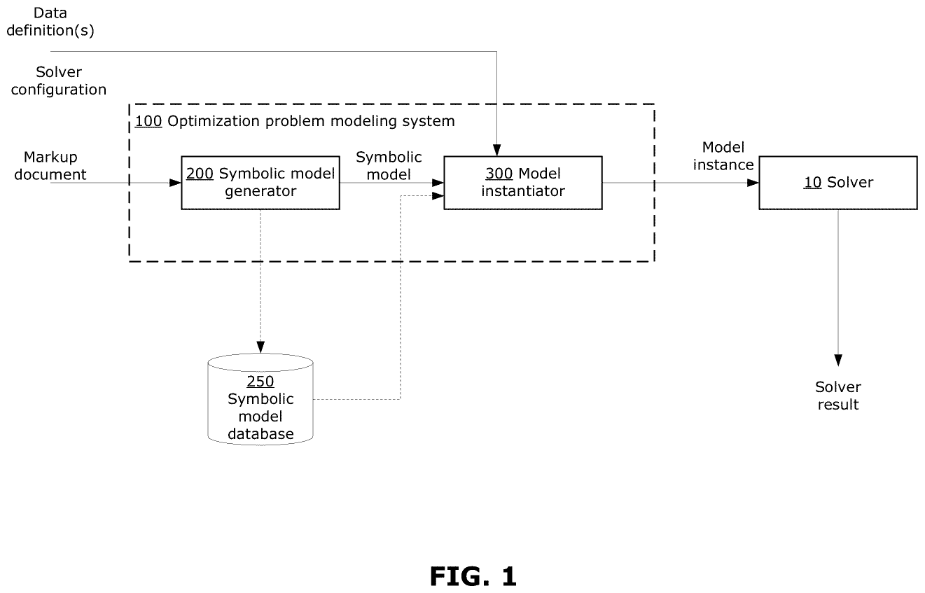

FIG. 1 is a schematic diagram illustrating an example optimization problem modeling system 100. The optimization problem modeling system 100 may be implemented in a single physical machine or device (e.g., implemented as a single computing device, such as a single workstation, single server, etc.), or may be implemented using a plurality of physical machines or devices (e.g., implemented as a server cluster). For example, the optimization problem modeling system 100 may be implemented as a virtual machine or a cloud-based service (e.g., implemented using a cloud computing platform providing a virtualized pool of computing resources). In some examples, the optimization problem model system 100 may provide cloud-based services accessible to a user device.

In this example, the optimization problem modeling system 100 is in communication (e.g., over a wired or wireless network) with a solver 10 and is optionally in communication with a symbolic model database 250. The symbolic model database 250 may be external to the optimization problem modeling system 100 (as shown) or may be part of the optimization problem modeling system 100. The optimization problem modeling system 100 may also be in optional communication with one or more user devices (not shown). In some examples, the optimization problem modeling system 100 may not be in direct communication with the solver 10. For example, instead of the optimization problem modeling system 100 directly providing the model instance to the solver 10, the optimization problem modeling system 100 may output the model instance (e.g., as computer-readable code stored on a tangible medium, such as a removable memory), and the model instance may be provided to the solver 10 at some later time.

In the example shown, the optimization problem modeling system 100 includes a symbolic model generator 200 and a model instantiator 300 as subsystems. In other examples, the symbolic model generator 200 and the model instantiator 300 may be standalone systems that communicate with each other. In yet other examples, the optimization problem modeling system 100 may itself provide the functions of symbolic model generation and model instantiation, without having subsystem 200, 300. It should be understood that the optimization problem modeling system 100 may be implemented using various hardware and software, and is not intended to be limited to the example shown in FIG. 1.

The symbolic model generator 200 receives as input a markup document (which may be in a digital format) representing an optimization problem. An optimization problem may describe a real-world decision-making scenario, and may be represented by mathematical formulas and symbols (which may model the real-world scenario). There may be different types of optimization problems, which may all be addressed by examples of the present disclosure, such as linear programming, quadratic programming, mixed-integer programming, etc.

The markup document may be provided from a user device, for example. As previously mentioned, the markup document may be an unstructured, multimodal document meaning that the markup document includes both human language content and mathematical content, and the content does not necessarily follow a defined structure. The markup document uses a markup language (e.g., using TeX, LaTeX, Markdown or XML) to describe the optimization problem using some combination of natural human language (e.g., human-understandable text) and mathematical representation (e.g., mathematical formulas and symbols). The markup document is processed by the symbolic model generator 200 to generate a symbolic model. The symbolic model describes the optimization problem using mathematical representation only (i.e., without textual descriptors). As will be described further below, the symbolic model generator 200 may extract semantic metadata and associate the semantic metadata with the generated symbolic model. Optionally, the symbolic model and associated semantic metadata may be stored in the symbolic model database 250.

The symbolic model is received as input to the model instantiator 300. The symbolic model may be provided to the model instantiator 300 directly by the symbolic model generator 200, or optionally may be retrieved from the symbolic model database 250. The model instantiator 300 also receives as input one or more data definitions (e.g., from a user device), which provide the numerical values of sets and parameters which are used to provide defined values to the symbolic constraints and objective of the symbolic model. Optionally, the model instantiator 300 may also receive information about the solver configuration (e.g., from a user device). For example, the model instantiator 300 may receive an indication or selection of the solver application programming interface (API) to use. A solver API is a software tool that provides an interface with a particular solver 10. The solver API provides tools that may be used by the model instantiator 300 to generate a model instance. In some examples, if the model instantiator 300 does not receive information about the solver configuration, a default solver API may be used.

The model instantiator 300 generates a model instance. The model instance may be in the form of computer-readable code (e.g., using coding language executable by the solver 10) that can be processed by the solver 10. The model instance is a computer-readable representation of the optimization problem, in which the values of the parameters and constraints (which are defined symbolically in the symbolic model) have been defined numerically using the data definitions. It should be understood that the model instantiator 300 may generate different model instances for the same symbolic model, using different data definitions. The model instance is provided as input to the solver 10, which processes the model instance to generate a solver result that solves the objective function of the optimization problem while adhering to the constraints. The solver result may be used as a solution to the optimization problem.

As previously mentioned, the optimization problem modeling system 100 may be implemented using different hardware configurations. An example computing system that may be used to implement the optimization problem modeling system 100 is now described.

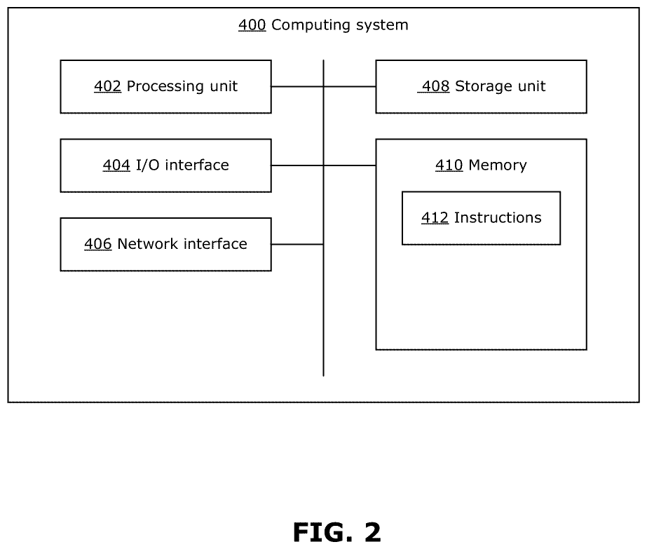

FIG. 2 is a block diagram illustrating a simplified example computing system 400 that may be used for implementing the optimization problem modeling system 100, in some embodiments. The computing system 400 may represent a server or a workstation, for example. As discussed previously, the optimization problem modeling system 100 may be implemented in other hardware configurations, including implementation using a plurality of computing systems. Although FIG. 2 shows a single instance of each component, there may be multiple instances of each component in the computing system 400. The computing system 400 may be used to execute instructions for training a neural network and/or for executing a trained neural network, as discussed further below.

In this example, the computing system 400 includes at least one processing unit 402, which may be a processor, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, combinations thereof, or other such hardware structure.

The computing system 400 may include an input/output (I/O) interface 404, which may enable interfacing with an input device and/or output device (not shown).

The computing system 400 may include a network interface 406 for wired or wireless communication with other computing systems (e.g., the symbolic model database 250, the solver 10, a user device, etc.). The network interface 406 may include wired links (e.g., Ethernet cable) and/or wireless links (e.g., one or more antennas) for intra-network and/or inter-network communications. The network interface 406 may also enable the computing system 400 to communicate generated reports to another computing system (e.g., to a user device).

The computing system 400 may include a storage unit 408, which may include a mass storage unit such as a solid state drive, a hard disk drive, a magnetic disk drive and/or an optical disk drive.

The computing system 400 may include a memory 410, which may include a volatile or non-volatile memory (e.g., a flash memory, a random access memory (RAM), and/or a read-only memory (ROM)). The non-transitory memory 410 may store instructions for execution by the processing unit 402, such as to carry out example embodiments described in the present disclosure. For example, the memory 410 may store instructions 412 for implementing the optimization problem modeling system 100 as well as any of the methods disclosed herein. The memory 410 may also store neural network parameters, which may be parameters learned from training a neural network, such as in examples where the optimization problem modeling system 100 is implemented using a neural network. The memory 410 may include other software instructions, such as for implementing an operating system and other applications/functions.

The computing system 400 may additionally or alternatively execute instructions from an external memory (e.g., an external drive in wired or wireless communication with the server) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

Reference is again made to FIG. 1. The optimization problem modeling system 100 helps to improve accessibility and usability of solvers, by automatically parsing a markup document (which is an unstructured multimodal document having a mix of text and math content) into a symbolic model (which contains only math content) using the symbolic model generator 200, and then using the model instantiator 300 to process the symbolic model to generate a model instance (which is in computer-readable code) that can be inputted to the solver 10. The processing of the markup document into a model instance can be performed without the need for the knowledge of an OR expert.

It may be noted that generation of the symbolic model by the symbolic model generator and instantiation of the model instance by the model instantiator 300 may be decoupled, meaning that the data definitions may be defined at any time, asynchronously from creation of the markup document and generation of the symbolic model. Further, the markup document and the data definitions may be independently updated at any time or a new solver 10 can be selected at any time, and a new model instance can be generated. This may enable a more efficient process for solving an optimization problem.

Details of the symbolic model generator 200 are first discussed.

The symbolic model generator 200 performs functions to the markup document into a symbolic model. The symbolic model generator 200 may accept a multimodal, unstructured markup document as input, without requiring the markup document to follow a specific structure or to use specific language. A non-OR expert may generate the markup document using any suitable markup language (e.g., TeX, LaTeX, Markdown, XML, etc.), using any suitable combination of natural human language text (e.g., English language text formatted into paragraphs, bullet points, section headers, etc.) and math content (e.g., symbols, equations, etc.).

The symbolic model generator 200 may use hierarchical parsing techniques to process the unstructured markup document, without requiring intervention by an OR expert or other human, and without requiring the use of specific structured input or keywords. The hierarchical parsing technique may parse the markup document by first detecting higher-level components of the symbolic model (e.g., natural language text or math content describing a constraint), then further parse the lower-level building blocks (e.g., symbolic variables and/or parameters). The higher-level parsing may serve to categorize unstructured input into one of several defined classes of optimization problem components (e.g., constraint, objective, variable, etc.). Then, the lower-level parsing may be specialized for each defined class of optimization problem component.

The symbolic model generator 200 enables semantic metadata from a markup document to be extracted and associated with the symbolic model. Metadata in the markup document may include human language text that describes and gives meaning to the symbolic components of the optimization problem. Conventionally, such metadata is used to help the OR expert to understand the context of the optimization problem but is not included in the model designed by the OR expert. This makes it difficult for a non-OR expert to understand or make adjustments to the model. The disclosed symbolic model generator 200 performs operations to automatically parse and extract semantic metadata from the markup document, and to store the extracted semantic metadata in relation to the corresponding symbolic components. This helps to improve user accessibility of the symbolic model. As well, the symbolic models stored in the symbolic model database 250 may be searchable using the associated metadata.

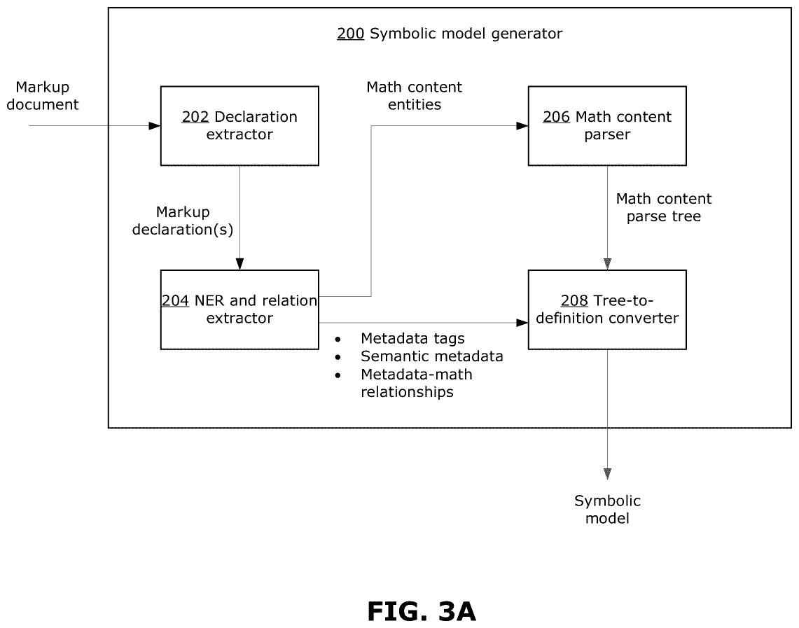

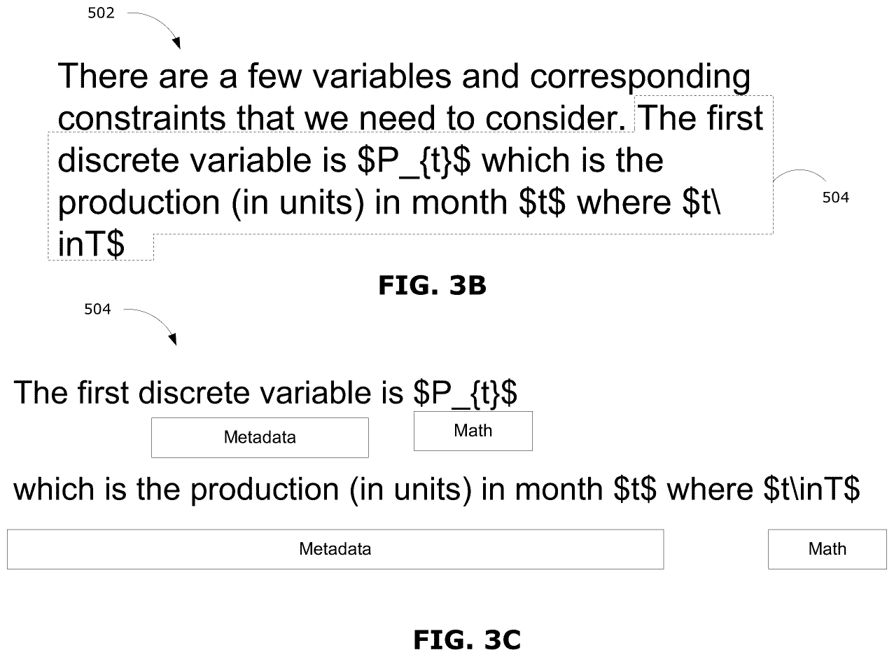

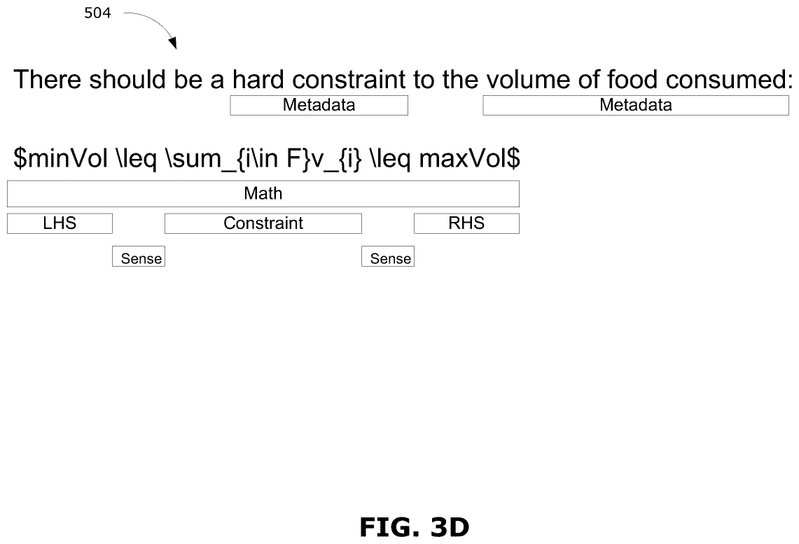

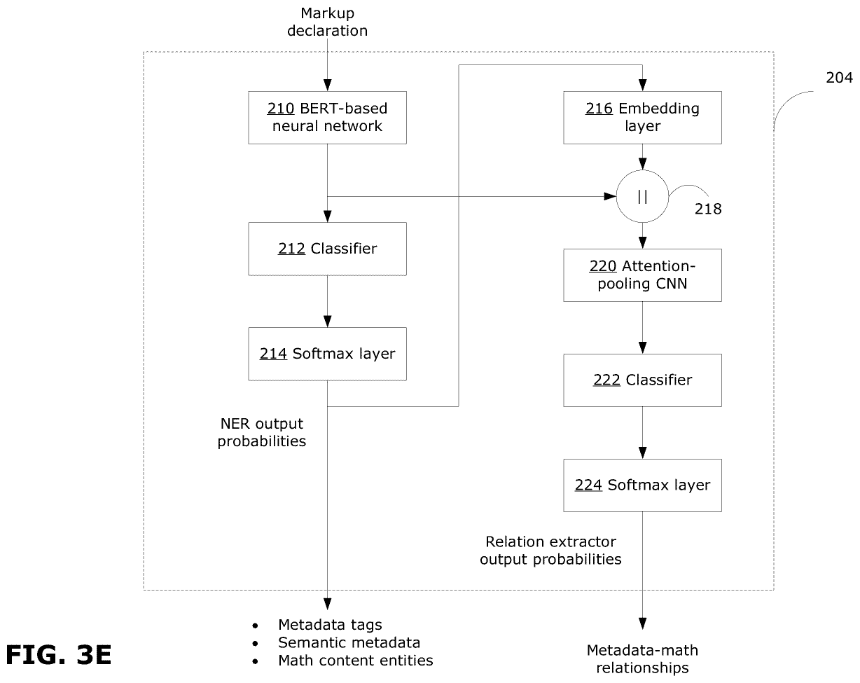

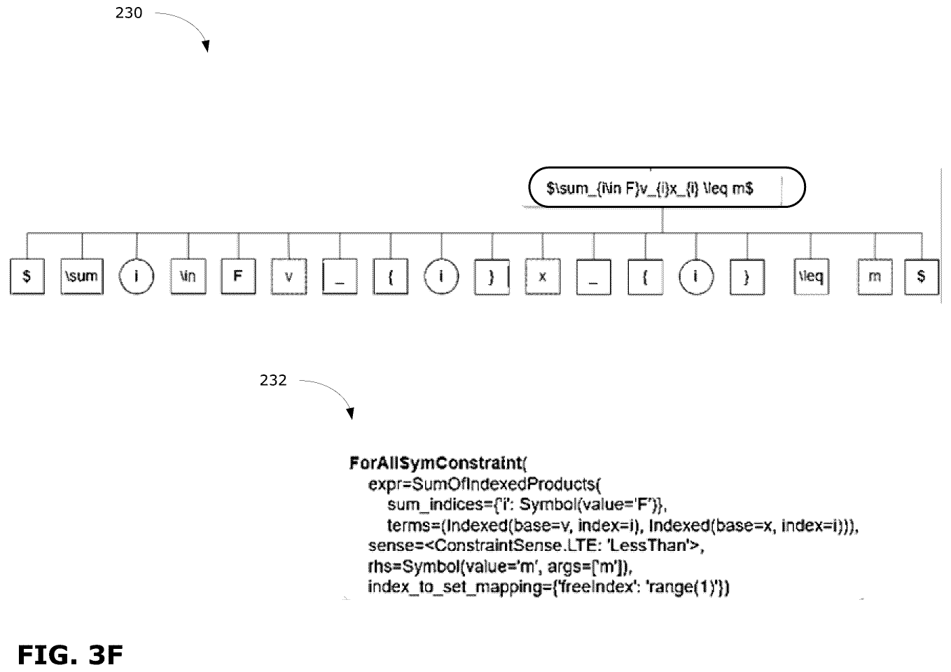

FIG. 3A is a block diagram illustrating an example implementation of the symbolic model generator 200. Although the symbolic model generator 200 is illustrated with certain functional blocks, it should be understood that this is not intended to be limiting.

The symbolic model generator 200 accepts a markup document as input. Hierarchical parsing of the markup document is performed by a declaration extractor 202 (which may be considered a high-level parser), followed by a named entity recognition (NER) and relation extractor 204 (which may be considered a mid-level parser), followed by a math content parser 206 (which may be considered a low-level parser). Finally, a tree-to-definition converter 208 converts the parsed content into a symbolic model.

The declaration extractor 202 performs content segmentation on the markup document to extract content segments that correspond to markup declarations. A markup declaration is a segment of symbols and optionally text that can be categorized as one of several defined declaration types, namely parameters, sets, decision variables, constraints or objectives. In the present disclosure, a parameter refers to a constant (typically represented as a symbolic parameter) that is used to define constraints and objectives; a set refers to all possible values of the indices for a decision variable or parameter; a decision variable is a variable that is changed to reach the goal of the optimization problem (typically solving the optimization problem involves finding the optimal value for the decision variable); a constraint is a mathematical expression that defines the boundaries or limitations of the optimization problem (e.g., number of people must be a non-negative integer, maximum weight of goods that can be carried on a truck, etc.); and an objective is a mathematical expression that defines the goal of the optimization problem (e.g., minimize a cost, maximize an amount of a nutrient, etc.).

The declaration extractor 202 may use any suitable content segmentation technique to extract these declarations. For example, the declaration extractor 202 may be a rules-based parser that identifies and segments declarations from the markup document using defined rules of grammar, math, etc. In another example, the declaration extractor 202 may be implemented using a text segmentation neural network that has been trained to identify the defined declaration types and to extract the declarations.

For example, the declaration extractor 202 may be a neural network that is based on a pre-trained bidirectional encoder representations from transformers (BERT) neural network. The declaration extractor 202 may be trained using a training dataset comprising unstructured markup documents in which the content has been segmented and labeled as one of the defined declaration types. For example, a hierarchical sequence labeling technique may be used to annotate unstructured markup documents to generate the training dataset. The training dataset may include labels identifying semantic metadata, metadata tags, and math content entities. There may also be labels nested within labels, for example a math content entity may be labeled and left-hand-side, right-hand-side and constraint sense labels may also be found (or “nested”) within the math content entity label.

FIG. 3B illustrates an example of annotated training data, which may be used to train the declaration extractor 202.

As shown in FIG. 3B, a portion of a markup document 502 has been annotated as containing a markup declaration 504 (indicated by a dashed box). The markup declaration 504 may be annotated by identifying the first and last characters of the markup declaration 504, for example. Other non-annotated content (not indicated by a dashed box in FIG. 3B) are not markup declarations.

A pre-trained BERT-based neural network may be trained on this annotated training dataset, using any suitable training method (e.g., using Adam optimizer). After sufficient training, the learned neural network weights may be stored in local memory and the trained neural network may be used as the declaration extractor 202. In some examples, fine-tuning and validation of the neural network may be performed. For example, fine-tuning and validation may be performed by using the neural network to extract declarations from a validation dataset, then minimizing cross-entropy losses including the error in prediction of an entity and the error in predicting the metadata or math content entity. The two losses may be combined together using a tunable hyperparameter that adjusts the weight of each loss. The neural network weights having the best performance on the validation dataset may be further evaluated using entity-level micro-averaged F1 score on a reserved test dataset. Other methods of learning and fine-tuning a natural language processing (NLP) neural network, which may be used to implement the declaration extractor 202, may be suitable within the context of the present disclosure.

Implementation of the declaration extractor 202 using a trained neural network to segment the content may enable effective parsing of unstructured markup documents, rather than requiring the markup document to follow a rigid structure.

The output from the declaration extractor 202 is one or more markup declarations that have been segmented from the markup document. Each markup declaration belongs to one of the defined declaration types (parameters, sets, decision variables, constraints or objectives), includes math content (e.g., math operators and/or symbols) and may optionally include natural language text (e.g., English language text). For example, a markup declaration may be a statement defining the meaning of a variable (e.g., “The first discrete variable is $P_{t}$ which is the production (in units) in month $t$ where $t\inT$.”). It should be noted that not all content in the markup document may be a markup declaration. For example, the markup document may include textual content such as title, introduction, etc. that are not declarations.

Each of the markup declaration(s) is then processed by the NER and relation extractor 204. The NER and relation extractor 204 performs the joint task of detecting metadata entities (if any) and math content entities, and (if metadata entities are detected) extracting the relationship between the detected metadata entities and math content entities. In general, NER may refer to the task of labeling content segments using a label from a predefined list of available entity labels, and relation extraction may refer to the task of generating relationships between labeled content segments from a predefined list of possible relationships.

By metadata entity, it is meant a segment of human language content (e.g., English language text) that is identified as metadata; by math content entity, it is meant a segment of content (e.g., symbolic content) that is identified as math content. A math content entity includes a string of one or more mathematical symbols or characters. A math content entity may be characterized by its span, which describes the location of the entity within the declaration and the length of the entity. Thus, the NER and relation extractor 204 segments each markup declaration into math content (e.g., symbols, equations, etc.), metadata (e.g., text descriptors) if there is human language content in the declaration, and (if metadata is present in the declaration) also generates relationship data relating a metadata entity to the corresponding math content.

The metadata entities may be categorized as metadata tags and semantic metadata. In general, each metadata entity provides some information about the meaning of a related math content entity in the declaration. Metadata tags are text that describe information needed to build the symbolic model, for example text defining the type of variable (e.g., discrete variable, integer, continuous, etc.) or text defining the meaning of the objective (e.g., minimize or maximize). Semantic metadata are text that provide the meaning and definition of the math content, such as set definitions, variable definitions, objective name, constraint names, constraint attributes (e.g., constraint sense, right hand side expression, etc.) and model attributes (e.g., number of variables, number of constraints, etc.). In general, semantic metadata may provide contextual information to help a human user to understand the components of the symbolic model. A metadata tag or semantic metadata may thus provide information for a human to understand the related math content entity, and also may provide information about how the related math content entity should be defined in the symbolic model. It should be understood that a declaration may content only math content, without any metadata tag or semantic metadata. For example, the declaration may contain only math content whose symbolic variables have been defined by metadata in a prior declaration in the markup document.

Relationship data may be in the form of links (e.g., vectors) that relate a metadata entity to the relevant math content entity in the declaration. It may be noted that, in an unstructured markup document, it may be difficult to identify the relationship between a metadata entity and a math content entity using a grammar-based or rules-based approach. Implementation of the NER and relation extractor 204 using a trained neural network, which may be based on NLP, may enable greater accuracy in relating metadata entities with math content entities, while allowing for flexibility in how a human domain expert writes the markup document.

As an example, a markup declaration such as “The first discrete variable is $P_{t}$ which is the production (in units) in month $t$ where $t\inT$” may be parsed by the NER and relation extractor 204 into a metadata tag “discrete variable”, semantic metadata “the production (in units) in month $t$” and math content “$P_{t}$” and “$t\inT$”. A segment of math content may be identified as a math content entity and characterized using a math content span, which defines the start and end of a single contiguous segment of math content. A math content entity may be short (e.g., a single variable) or long (e.g., a constraint equation). The NER and relation extractor 204 may further relate the metadata tag “discrete variable” and the semantic metadata “the production (in units) in month $t$” to the math content “$P_{t}$”. Further, the math content “$t\inT$” may be supplemental to “$P_{t}$” and thus may be related as supplementary math content.

In another example, a markup document may include metadata that describes a symbolic variable P as “number of people”. The metadata “number of people” may be extracted by the NER and relation extractor 204 to be a metadata tag for a “discrete variable” related to the symbolic variable P. In yet another example, the markup document may state that the symbolic objective function P_{i}*X{i} “must be amplified”, which may be extracted as by the NER and relation extractor 204 as an objective sense “maximize” related to the symbolic expression P_{i}*X{i}. Thus, the NER and relation extractor may be trained to extract the metadata (if present in the declaration) and may additionally be trained to understand the mathematical sense (or semantic meaning) of the metadata.

The NER and relation extractor 204 may be another trained neural network (e.g., based on a pre-trained BERT neural network) that has been trained using a training dataset comprising annotated segments (e.g., segments of text and/or math content that have been annotated with labels for math content entities, metadata tags, relationships, etc.). The neural network that may be used to implement the NER and relation extractor 204 may be trained in a manner similar to that described above with respect to the declaration extractor 202.

FIG. 3C illustrates an example of annotated training data, which may be used to train the NER and relation extractor 204. As shown in FIG. 3C, a markup declaration 504 has been annotated with labels indicating metadata entities and labels indicating math content. FIG. 3D illustrates another example, in which another markup declaration 504 has been annotated with labels indicating metadata entities and a label indicating math content. Additionally, there are nested labels within the math label indicating the meaning of the math content (e.g., “LHS”, “RHS”, “constraint” and “sense” labels). The annotations may be created using any suitable labeling software that support nested labels, for example. Although not shown, the annotated training data may also include links indicating the relationship between metadata and math content.

FIG. 3E illustrates an example neural network architecture, which may be used to implement the NER and relation extractor 204. It should be understood that this is not intended to be limiting, and other neural network architectures may be suitable. For example, a suitable architecture for the NER and relation extractor 204 is described by Giorgi et al. (“End-to-end Named Entity Recognition and Relation Extraction using Pre-trained Language Models”, arXiv:1912.13415, 2019).

The NER and relation extractor 204 may be thought of as having two interconnected branches, namely a NER branch that enables extraction of metadata tags, semantic metadata and math content entities, and a relation extractor branch that enables extraction of the metadata-math relationships. The NER branch includes a pre-trained BERT-based neural network 210 (e.g., as described by Devlin et al., “BERT: Pre-training of Deep Bidirectional Transformers for Language Understanding”, 2019) that processes the markup declarations into embeddings, followed by a classifier subnetwork 212 and a softmax layer 214. The output of the softmax layer 214 are NER output probabilities, which are used to predict the metadata tags, semantic metadata and math content entities.

The relation extractor branch accepts the NER output probabilities and coverts the token IDs of the predicted entity labels into embeddings using an embedding layer 216. The converted embeddings are processed together with the embeddings generated by the BERT-based neural network 210 at a concatenation operation 218. This is followed by an attention-pool convolutional neural network (CNN) subnetwork 220 (e.g., as described by Wang et al., “Relation Classification via Multi-Level Attention CNNs”, 2016), a classifier subnetwork 222 and a softmax layer 224. The output of the softmax layer 224 are relation extractor output probabilities, which are used to predict the metadata-math relationships.

Thus, the NER and relation extractor 204 parses a single markup declaration into one or more math content entities (which may include a main math content entity and one or more supplementary math content entities), possibly one or more metadata tags, possibly one or more semantic metadata and/or one or more metadata-math relationships if at least one metadata tag or semantic metadata was extracted. The NER and relation extractor 204 may be trained to identify a math content entity in a markup declaration as being a supplemental math content entity that is related to another math content entity (which may be considered the main math content entity). The supplemental math content entity may be related to another math content entity within the same markup declaration, and the NER and relation extractor 204 may be trained to extract the relationship between the supplemental math content entity and the main math content entity. For example, the declaration extractor 202 may be trained to extract a markup declaration having multiple math content entities (e.g., trained using annotated training data where an annotated declaration is further annotated to contain multiple math content entities), and the NER and relation extractor 204 may be trained to identify each math content entity in the markup declaration as being a main math content entity or a supplemental math content entity, and further identify the relationship between the main math content entity and each supplemental math content entity (e.g., trained using annotated training data where math content entities are labeled as being supplemental or main, and further labeled with relationships to each other).

Each math content entity is processed by the math content parser 206. The math content parser 206 accepts a math content entity as input and extracts math content and their relationships. The output of the math content parser 206 is a math content parse tree that is a tree data structure representing the components and relationships of the math content entity. For example, a simply math content entity consisting of two symbols with an operator in between (e.g., “a+b”) is parsed by the math content parse 206 into a math content parse tree where each symbol and operator form a node of the math content parse tree, and where the math content entity forms the root of the math content parse tree (e.g., “a”, “+” and “b” would be leaf nodes of “a+b”). For a math content entity that includes an objective function, the math content parse 206 may output a more complex math content parse tree having nodes corresponding to the symbols and corresponding indices, operators, the formulas and senses (e.g., maximize, minimize) that make up the objective function. Each of the one or more math content entities extracted by the NER and relation extractor 204 are parsed by the math content parser 206, to obtain respective one or more math content parse trees.

The math content parser 206 may be implemented using any suitable parser algorithm that is designed to parse mathematical expressions in accordance with defined mathematical syntax. For example, a context-free grammar-based parser (e.g., generated using the ANTLR parser generator, for example as described by Parr et al. “LL(*): The Foundation of the ANTLR Parser Generator”, 2011) may be used as the math content parser 206. It should be understood that, because the math content parser 206 is expected to parse math content entities that are in the context of an optimization problem, the types of mathematical expressions that the math content parser 206 is expected to parse may be smaller than the pool of all possible mathematical expressions. This may help to simplify the implementation of the math content parser 206 (e.g., only certain types of math syntax may need to be recognized by the math content parser 206).

The math content parse trees generated by the math content parser 206, and any metadata tags, semantic metadata and metadata-math relationships generated by the NER and relation extractor 204 are processed by the tree-to-definition converter 208 to generate the symbolic model. The symbolic model may be considered a data structure that represents the mathematical formulation of the optimization problem. The symbolic model contains symbolic code, which is a structured way of representing the math content, however the symbolic code is not necessarily solver code (i.e., the symbolic code does not necessarily use computing coding language that is compatible with the solver). The symbolic code may be converted into solver code by the model instantiator 300, as discussed further below. The tree-to-definition converter 208 processes each math content parse tree by walking through each node and, if there is any corresponding metadata, relating the corresponding metadata (e.g., metadata tags and semantic metadata), based on the metadata-math relationships. The tree-to-definition converter 208 may then use predefined logic to convert the relationships represented by the math content parse tree and any metadata into symbolic code. For example, consider the example math content parse tree illustrated in FIG. 3F.

In FIG. 3F, an example math content parse tree 230 for the symbolic expression “$\sum_{i\in F}v_{i}x_{i} \leq m$” is shown. The math content parse tree 230 includes a leaf node containing the keyword “\sum”. The tree-to-definition converter 208 may follow a predefined rule that nearby leaf nodes contain symbols that describe the indices that are bound to the sum. In this case, the node “i” is determined to be the index and the node “\in” is detected as another keyword that connects the symbol “F” to the index. The tree-to-definition converter 208 may also detect other variables and parameters (such as “v”, “x” and “m”) and any corresponding indices (e.g., following a predefined rule that indices are identified between the braces “{” and “}”). In this example, the math content represented by the math content parse tree 230 is related to the metadata tag “constraint”, thus the tree-to-definition converter 208 may use predefined logic to convert these recognized fields to code for a constraint. The tree-to-definition converter 208 may follow a predefined rule that the node “\leq” is a keyword that identifies the constraint sense (in this case the constraint sense is “less than or equal to”). As a result, the tree-to-definition converter 208 generates the code for a constraint where a sum on the left hand side is constrained to be less than or equal to a value on the right hand side, for example the code “ForAllSymConstraint” 232.

As previously mentioned, in some examples a given declaration may contain only one or more math content entities, without any metadata entities or metadata-math relationships. In such examples, only the math content parse tree generated by the math content parse 206 may be used by the tree-to-definition converter 208 to generate the symbolic code corresponding to the given declaration. After all math content parse trees have been processed, the result is a symbolic model that is a representation of the optimization problem, stripped of irrelevant information such as markup-language-specific requirements, human language tags, irrelevant delimiters/symbols, etc.

It should be noted that, although the symbolic model does not contain semantic metadata (e.g., metadata containing human language text to help explain the optimization problem), the semantic metadata is nonetheless related to corresponding math content by the metadata-math relationships. The optimization problem modeling system 100 may enable the symbolic model or components of the symbolic model to be presented together with the related semantic metadata (e.g., presented via a user interface displayed on a user device), to enable a human user (e.g., a non-OR expert) to understand the symbolic model.

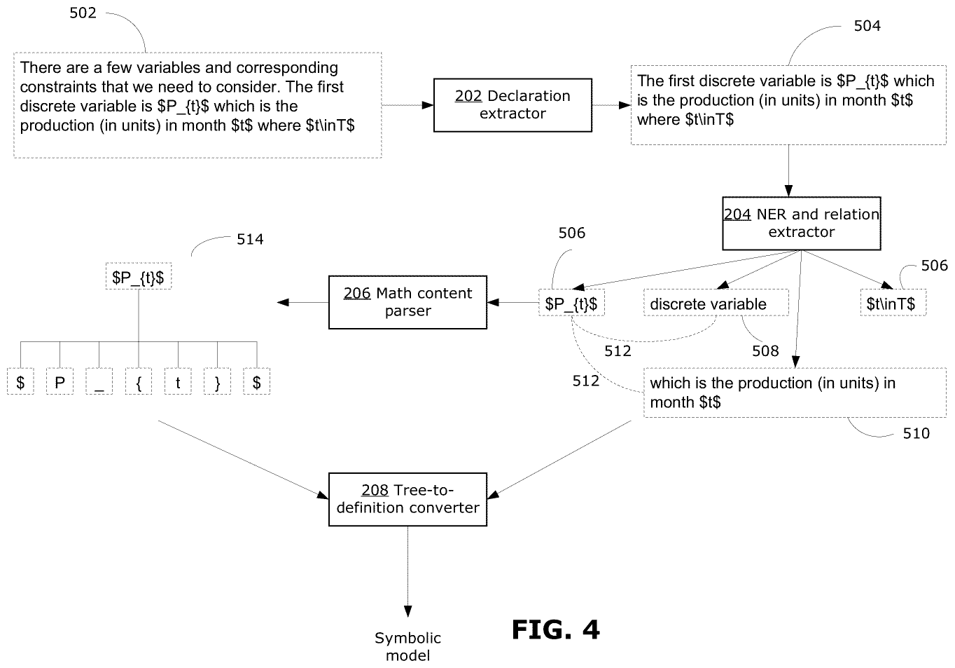

FIG. 4 illustrates a simplified example of how a markup document may be processed by the symbolic model generator 200. It should be understood that only a portion of a markup document is shown and described below for ease of understanding, however the symbolic model generator 200 may process an entire markup document rather than only a portion of a markup document.

A markup document 502 is received and processed by the declaration extractor 202. The declaration extractor 202 extracts the markup declaration 504, ignoring other text in the markup document 502. The markup declaration 504 is processed by the NER and relation extractor 204, which extracts math content entities 506, metadata tag 508 and semantic metadata 510. The NER and relation extractor 204 also extracts the metadata-math relationships 512 (indicated by curved dashed lines) that relate the extracted metadata 508, 510 to the math content entity 506. Each extracted math content entity 506 is processed by the math content parser 206 into a math content parse tree 512 (for simplicity, the math content parse tree 512 is shown for only one math content entity 506). The math content parse tree 512, together with the metadata 508, 510 and metadata-math relationships 512, are processed by the tree-to-definition converter 208 to generate the symbolic model. The generated symbolic model is associated with the extracted semantic metadata. In particular, each symbolic component (e.g., symbolic variable, equation, parameter, etc.) of the symbolic model may be associated with the corresponding semantic metadata describing the meaning of the symbolic component using human language.

Optionally, the symbolic model may be saved, for example stored in a symbolic model database 250 which may be local to the optimization modeling system 100 or may be an external database. The symbolic model may be stored in association with its corresponding semantic metadata.

The symbolic model database 250 may be searchable, to enable a user to identify the desired symbolic model from all symbolic models stored in the symbolic model database 250. The optimization problem modeling system 100 may provide a UI (not shown) that accepts a text string as a query, and may implement a search engine that identifies all stored symbolic models having associated semantic metadata matching the query and returns the identified symbolic models as search results. In this way, by storing each symbolic model in association with its corresponding semantic metadata, the stored symbolic models may be more easily searched by a user. In some examples, a stored symbolic model may be retrieved by a user to be used as a template for developing a new symbolic model.

Optionally, the symbolic model or components of the symbolic model may be outputted to be displayed by a display screen or other output device of the optimization problem modeling system 100 or of a user device in communication with the optimization problem modeling system 100. This may enable a user to identify any errors in how the optimization problem was defined in the markup document (e.g., a missing parameter may be easily identified).

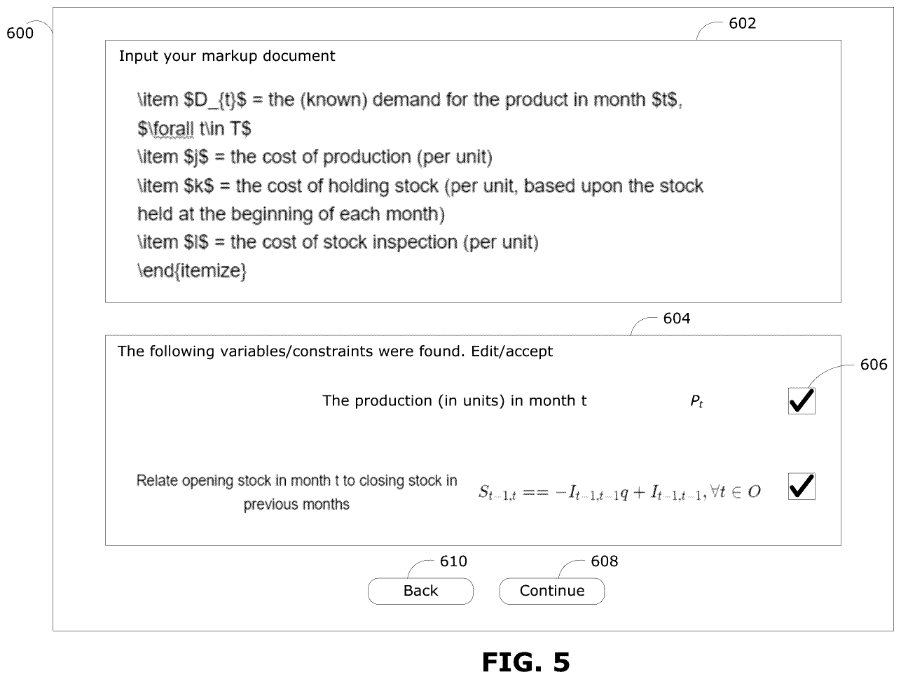

FIG. 5 illustrates an example user interface (UI) 600, which may be displayed to a user. The UI 600 includes an input field 602 in which the markup document is displayed. The markup document may be inputted to the input field 602 manually (e.g., by a user manually typing in the markup document, or copying the contents of the markup document into the input field) or may be uploaded from a memory of the user device, for example. After processing by at least the declaration extractor 202 and the NER and relation extractor 204, the symbolic components (e.g., symbolic parameters, variables, equations, constraints, etc.) that have been identified may be displayed in a symbolic field 604.

The user may be provided with options 606 to verify, accept or edit (e.g., manually adding, removing or changing a constraint, changing the detected type of a declaration, etc.) each symbolic component. It may be noted that the symbolic field 604 displays each symbolic component together with the semantic metadata that has been related to the symbolic component. This may help a non-OR expert to understand the meaning of each symbolic component, thus improving comprehension and/or accessibility, as well as enabling the symbolic model to be edited more efficiently.

The user may be provided with an option 608 to accept the identified symbolic components (after any editing by the user) and proceed to generate the symbolic model. The user may also be provided with an option 610 to return to a previous step, for example to upload a different markup document.

It should be understood that the UI 600 is only exemplary, and is not intended to be limiting.

The symbolic model, after being generated by the symbolic model generator 200, may be processed by the model instantiator 300 into a model instance. As previously mentioned, the symbolic model may be stored in the symbolic model database 250 after being generated. The model instantiator 300 may, at some later time, retrieve the symbolic model from the symbolic model database 250 to be instantiated into a model instance.

As previously mentioned, the model instantiator 300 enables instantiation of a model instance from a symbolic model. This means that the symbolic model can be decoupled from the data definitions, enabling different model instances to be generated using different combinations of formats for the markup document and the data definitions (e.g., the format of the data definitions does not need to depend on the markup language used for the markup document, and vice versa). Some existing approaches to modeling optimization problems require the markup document to use math formulas that correspond exactly with the data definitions, and any changes to the data definitions (e.g., as new data is collected, or new parameters are introduced to the optimization problem) require the expertise of an OR expert to develop a new model instance. This can be costly and time-consuming, and can be avoided by examples of the present disclosure.

The model instantiator 300 is able to generate a model instance to suit any appropriate solver 10. The user may only need to indicate the desired solver configuration, and there is no need for the markup document or the data definitions to be created in a specific format required by the solver 10. This may also enable different solvers 10 to be used to solve the optimization problem defined by the same markup document and the same data definitions.

In general, the model instantiator 300 may perform functions to convert the data definitions (which may be received as a single data definitions file, or each data definition may be a respective data definition file) into a format that suits the configuration of the selected solver 10 (e.g., the format in which sets and parameters are defined, in accordance with the selected solver API). The model instantiator 300 also defines the variables and all possible types according to the selected solver configuration, processes symbolic expressions in the symbolic model to define constraints and objectives according to the selected solver configuration, and generates a model instance that can be accepted by the solver 10. The generated model instance may be passed directly to the solver 10 to generate a solver result for the optimization problem and/or the model instance may be saved (e.g., saved as a .mps file in an internal or external memory) for future use.

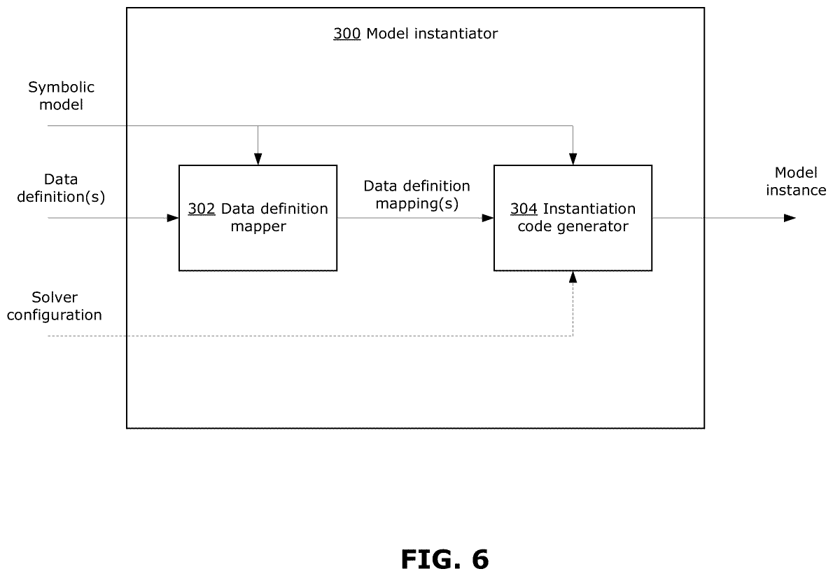

FIG. 6 is a block diagram illustrating an example implementation of the model instantiator 300. Although the model instantiator 300 is illustrated with certain functional blocks, it should be understood that this is not intended to be limiting.

The model instantiator 300 accepts a symbolic model as input, as well as one or more data definitions. Optionally, a solver configuration (e.g., an indication of the solver API to be used to generate the model instance) may also be provided as input to the model instantiator 300. If a solver configuration is not provided to the model instantiator 300, a default solver configuration (e.g., a default solver API) may be used.

The symbolic model and the data definitions are processed by a data definition mapper 302 into data definition mappings. The data definitions mappings contain the data definitions and map each data definition to the corresponding symbolic parameter of the symbolic model. The symbolic model, data definition mappings and optional solver configuration are processed by an instantiation code generator 304 to generate the model instance, which is in the form of computer-readable code that can be accepted as input by the solver 10 (i.e., in the form of solver code).

The data definitions may be provided by the user (e.g., uploaded from the user device). Each data definition provides the numerical values for a respective symbolic set or symbolic parameter in the symbolic model. The data definitions may be provided as a software file or multiple software files (e.g., each file containing data definition for a respective parameter), or in any suitable format (such as being received as a data stream, or being manually entered). A common format for data definitions is a spreadsheet file in which data is presented in a tabular form (which is a common method of representing a two-dimensional parameter). In the example where a data definition is presented in tabular form, the parameter may be identified based on the file name (e.g., based on the file name corresponding to the symbol or semantic meaning of the parameter) and the column and row headers may correspond to indices.

The solver configuration may optionally be provided as user input that selects which solver API to use and/or which solver 10 will be used. For example, the solver configuration may provide an indication of which specific solver API to use (e.g., from among available solver APIs such as Pyomo API, PuLP API, etc.), and indication of the solver type (e.g., from among possible solver types such as OR-COIN, branch-and-bound, Cplex, etc.). The solver configuration may also indicate whether the model instance should be saved and/or exported to a particular a file format suitable for optimization models (e.g., .mps file, .rew file, .dua file, etc.).

The symbolic model and the data definitions are provided as input to the data definition mapper 302. The data definition mapper 302 generates data definition mappings. Each data definition mapping maps a respective data definition with the respective corresponding symbolic parameter defined in the symbolic code of the symbolic model. For example, the data definition mapper 302 may use a rules-based approach to identify symbolic parameters in the symbolic model (e.g., each symbolic parameter may be labeled as such in the symbolic model) and match each symbolic parameter with the data definition file having the same file name.

In some examples, any symbolic parameter that cannot be mapped to a data definition or any data definition that cannot be mapped to a symbolic parameter may be notified to the user. For example, a UI may be provided via a user device, in which notifications may be displayed for any discrepancies between the data definitions and the symbolic parameters of the symbolic model. This may provide feedback to the user to enable the user to collect or provide the missing data definition(s), or to enable the user to edit the symbolic model appropriately.

For example, if there is not data definition for a given symbolic parameter, the UI may display the symbolic parameter. The symbolic parameter may be displayed together with the associated semantic metadata, to enable the user to understand the meaning of the symbolic parameter. The symbolic parameter may also be displayed in the context of a math equation in which the symbolic parameter appears in the symbolic model. Optionally, a blank data definition template (e.g., a blank spreadsheet file) may be automatically generated with the appropriate index, heading, etc. which the user may use to collect the missing data definition.

The data definition mappings, the symbolic model and optionally the solver configuration are received by the instantiation code generator 304. The instantiation code generator 304 uses the data definition mappings to instantiate and load the numerical data values for the symbolic parameters defined in the symbolic model, according to the format defined by the solver API indicated by the solver configuration (or according to a default format if the solver configuration is not provided). The instantiation code generator 304 may use a classical post-processing approach to generate the code for the model instance, or may use a machine-learning approach (e.g., using an encoder-decoder model) to generate the model instance.

For example, if a classical post-processing approach is used by the instantiation code generator 304, the instantiation code generator 304 may process the symbolic model by using defined rules (e.g., based on the known structure of symbolic code) to convert statements in symbolic code to statements in solver code (according to the format defined by the solver API). The instantiation code generator 304 may use the data definition mappings to load numerical data values from the data definitions into solver code (e.g., if a data definition mapping maps the symbolic parameter a to a spreadsheet containing values “1, 2, 3” then the generated solver code may be “a=[1,2,3]”).

In another example, if a machine-learning approach is used by the instantiation code generator 304, the instantiation code generator 304 may be a trained encoder-decoder model. The encoder-decoder model may be trained using symbolic model-model instance pairs. Each symbolic model-model instance pair includes a symbolic model (and associated data definition mappings) that is paired with the target model instance. The encoder-decoder model may then be trained to encode the symbolic model (and associated data definition mappings) into a latent representation that is then decoded into the target model instance. In this way, the encoder-decoder model may be trained in a manner similar to a translator, in order to “translate” the symbolic model into the model instance.

The model instance may then be stored or may be directly provided to the solver 10, to generate a solver result for the optimization problem.

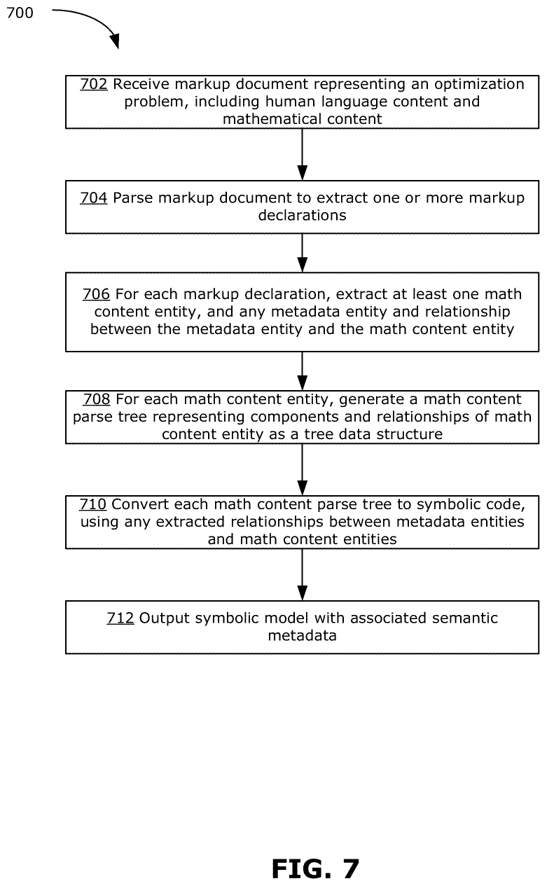

FIG. 7 is a flowchart illustrating an example method 700 for generating a symbolic model from a markup document. The method 700 may be performed by a computing system (e.g., the computing system 400) that is configured for executing instructions to implement the functions of the symbolic model generator 200 as described above. In some examples, the method 700 may be performed by a computing system that is configured for executing instructions to implement the optimization problem modeling system 100 (which may include the symbolic model generator 200 as a subsystem).

At 702, a markup document is received (e.g., from a user device) that represents an optimization problem. The markup document may be an unstructured, multimodal document that includes both human language content and mathematical content.

At 704, the markup document is parsed to extract one or more markup declarations from the markup document. As previously described, a trained neural network (e.g., a NLP-based neural network, which has been trained on an annotated training dataset) may be used to parse the markup document to extract the one or more markup declarations. For example, the declaration extractor 202 may be used to perform step 704.

At 706, each markup declaration is processed to extract at least one math content entity. If the declaration contains human language content, any metadata entity in the declaration and any relationship between an extracted metadata entity and an extracted math content entity is also extracted. As previously described, another trained neural network (e.g., a NLP-based neural network such as the neural network architecture shown in FIG. 3E, which has been trained on an annotated training dataset) may be used to process a markup declaration to extract one or more math content entities, as well as any metadata entities (e.g., metadata tag(s) and/or semantic metadata) and any metadata-math relationships (depending on the content of the declaration). For example, the NER and relation extractor 204 may be used to perform step 706.

At 708, each math content entity is processed to generate a respective math content parse tree. The math content parse tree is a tree data structure that represents the components of the math content entity (e.g., symbols and operators) and the relationships between the components. For example, the math content parser 206 (which may be generated using the ANTLR parser generator) may be used to perform step 708.

At 710, each math content parse tree is converted to symbolic code, to generate the symbolic model. If there are any metadata entities that are related to the math content entity represented by the math content parse tree, then the metadata entities are also used to generate the symbolic code from the math content parse tree. For example, a tree-to-definition converter 208 may process a math content parse tree together with any related metadata (identified by metadata-math relationships) to generate symbolic code.

After all math content parse trees have been processed, the symbolic model representing the optimization problem has been generated.

At 712, the symbolic model is outputted together with the associated semantic metadata. Each piece of metadata may be related to a respective symbolic content of the symbolic model, as defined by the metadata-math relationships.

The symbolic model and associated semantic metadata may be outputted to be stored in a memory (e.g., stored in the symbolic model database 250) and/or may be outputted to be instantiated into a model instance (e.g., instantiated by the model instantiator 300). Optionally, the symbolic model and associated semantic metadata may also be outputted to be displayed (e.g., via a UI on a user device) to a user, to enable the user to review and/or edit the symbolic model.

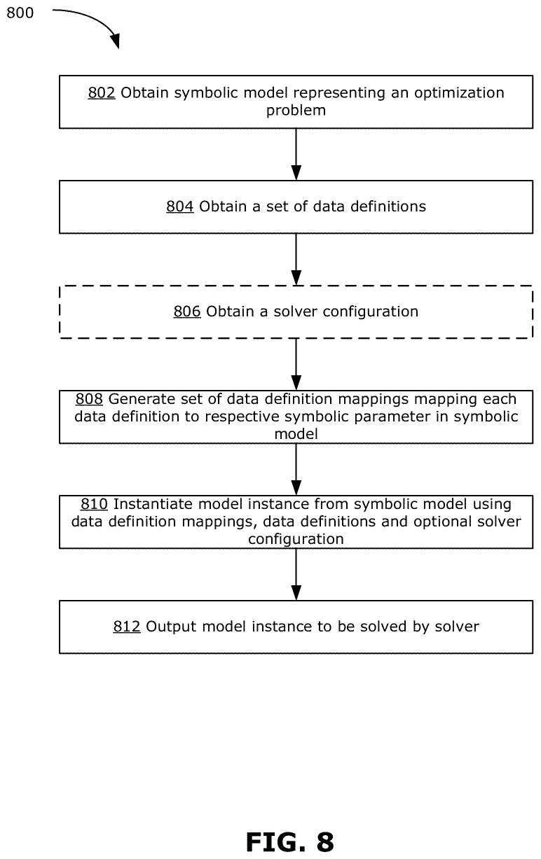

FIG. 8 is a flowchart illustrating an example method 800 for instantiating a model instance from a symbolic model. The method 800 may be performed by a computing system (e.g., the computing system 400) that is configured for executing instructions to implement the functions of the model instantiator 300 as described above. In some examples, the method 800 may be performed by a computing system that is configured for executing instructions to implement the optimization problem modeling system 100 (which may include the model instantiator 300 as a subsystem).

At 802, a symbolic model representing an optimization problem is obtained. The symbolic model may be obtained directly from the symbolic model generator 200 or may be obtained from the symbolic model database 250, for example.

At 804, one or more data definitions are obtained (e.g., received from a user device). The data definitions represent numerical values for symbolic parameters of the symbolic model. The data definitions may be obtained in any suitable format (e.g., spreadsheet file).

Optionally, at 806, a solver configuration may be obtained (e.g., received from a user device). The solver configuration may indicate a solver API to use or may indicate the solver 10 that will be used (thus implying the solver API to use). In some examples, the solver configuration may not be obtained and a default solver configuration (e.g., default solver API) may be used.

At 808, one or more data definition mappings are generated that map each data definition to a respective symbolic parameter in the symbolic model. For example, the data definition mapper 302 may use predefined rules to generate the data definition mappings (e.g., map each data definition to the respective symbolic parameter by matching the file name of each data definition to the semantic metadata related to each symbolic parameter).

Optionally, if there are any symbolic parameters that cannot be mapped to a data definition, or vice versa, a notification may be generated and outputted to the user device to notify the user of this discrepancy. This may enable the user to provide the missing data definition and/or edit the symbolic model appropriately.

At 810, a model instance is instantiated from the symbolic model using the data definition mappings, the data definitions and optionally the solver configuration. For example, the instantiation code generator 304 may use a classical post-processing approach or a machine-learning based approach to generate the model instance.

At 812, the generated model instance is outputted to be solved by a solver 10.

The methods 700 and 800 may be performed together (e.g., to generate a model instance from a markup document) or may be performed separately (e.g., to generate a symbolic model from a markup document, and separately generate a model instance from a symbolic model). The methods 700 and 800 may be performed by the same computing system, or may be performed by different computing systems.

Examples of the present disclosure may enable a non-OR expert to generate a symbolic model and a model instance from an unstructured, multimodal markup document describing an optimization problem. This may help to improve the accessibility of existing solvers for non-OR experts.

The present disclosure describes a hierarchical parsing approach to generate a symbolic model from a markup document. In other examples, a single neural network may be used to perform the parsing. For example, instead of having a declaration extractor as a separate component from the NER and relation extractor, a single machine-learning based component may be trained to perform both declaration extraction as well as named entity recognition and relation extraction.

The present disclosure describes methods and systems in which the conversion of the markup document to symbolic model, and the conversion of the symbolic model to the model instance are decoupled from each other. This may facilitate troubleshooting, model revision, etc. Decoupling of the symbolic model from the model instance enables model instantiation to be more flexible and adaptive to different data definition formats and/or different solver configurations. Further, the symbolic model may be saved, together with associated semantic metadata, and later retrieved by querying the associated semantic metadata. A saved symbolic model may also serve as a template for generating a new symbolic model.

In some examples, the symbolic model may not be stored in a database (or other memory), but may be directly instantiated into a model instance without being saved for future use.

Examples of the present disclosure may be provided as a cloud-based service (e.g., accessible to a user via a web-based portal, via a mobile application, via a software package, etc.). The present disclosure may be suitable for optimization problems in any domain (i.e., not limited to specific industries or applications).

In some examples, a UI may be provided to enable the user to provide input (e.g., input a markup document, edit parameters of the symbolic model, upload data definitions, etc.), to retrieve a symbolic model from a database (e.g., input a query to search the database), to review a symbolic model, etc. In some examples, a user may use the UI to search a symbolic model database for a symbolic model that may be used as a template for developing a new symbolic model. The UI may enable the user to view the symbolic parameters and equations of the symbolic model, together with the associated semantic metadata, to assist the user in understanding and editing the symbolic model.

Although examples have been described in which the inputted markup document is an unstructured, multimodal document, it should be understood that the present disclosure may also be applicable in cases where the markup document is structured (e.g., follows specific rules for definition the optimization problem), or contains only math content, for example.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computing system comprising:
a processing unit configured to execute computer-readable instructions to cause the system to:
receive a markup document representing an optimization problem the markup document containing human language content and mathematical content;
parse the markup document into a symbolic model containing only symbolic code representing the optimization problem by:
extracting at least one markup declaration from the markup document;
for the at least one markup declaration, extracting at least one respective math content span, and extracting any respective metadata entity and any relationship between the at least one respective math content span and any respective metadata entity;
for the at least one math content span, generating a respective math content parse tree; and
converting the respective math content parse tree to symbolic code using any relationship between the at least one respective math content span and any respective metadata entity, the symbolic code forming the symbolic model; and
output the symbolic model associated with semantic metadata containing the at least one respective metadata entity.

2. The computing system of claim 1, wherein the processing unit is further configured to execute the instructions to cause the system to:
implement a declaration extractor, using a first trained neural network, to extract the at least one markup declaration from the markup document; and
implement a named entity recognition and relation extractor, using a second trained neural network, to extract the at least one respective math content span, any respective metadata entity and any relationship between the at least one respective math content span and any respective metadata entity.

3. The computing system of claim 2, wherein the first trained neural network and the second trained neural network are each based on a pre-trained natural language processing neural network.

4. The computing system of claim 1, wherein the processing unit is further configured to execute the instructions to cause the system to:
provide a user interface for receiving the markup document and for displaying at least one symbolic parameter of the symbolic model, the at least one symbolic parameter corresponding to the at least one math content span, the at least one symbolic parameter being displayed with any related respective metadata entity.

5. The computing system of claim 4, wherein the processing unit is further configured to execute the instructions to cause the system to:
receive input to edit the at least one symbolic parameter.

6. The computing system of claim 1, wherein the symbolic model associated with the semantic metadata is stored in a symbolic model database.

7. The computing system of claim 1, wherein the processing unit is further configured to execute the instructions to cause the system to:
obtain at least one data definition;
generate at least one data definition mapping that maps the at least one data definition to at least one symbolic parameter of the symbolic model;
process the symbolic model, using the at least one data definition mapping and the at least one data definition, to generate a model instance; and
output the model instance to be solved by a solver.

8. The computing system of claim 7, wherein the processing unit is further configured to execute the instructions to cause the system to:
obtain a solver configuration;
wherein the model instance is generated according to the solver configuration.

9. The computing system of claim 7, wherein the processing unit is further configured to execute the instructions to cause the system to:
identify a discrepancy between the at least one data definition and the at least one symbolic parameter; and
output a notification indicating the discrepancy.

10. The computing system of claim 7, wherein the symbolic model is stored in a database, and wherein the processing unit is further configured to execute the instructions to cause the system to retrieve the symbolic model from the database in response to a query.

11. A method comprising:
receiving a markup document representing an optimization problem the markup document containing human language content and mathematical content;
parsing the markup document into a symbolic model containing only symbolic code representing the optimization problem by:
extracting at least one markup declaration from the markup document;
for the at least one markup declaration, extracting at least one respective math content span, and extracting any respective metadata entity and any relationship between the at least one respective math content span and any respective metadata entity;
for the at least one math content span, generating a respective math content parse tree; and
converting the respective math content parse tree to symbolic code using any relationship between the at least one respective math content span and any respective metadata entity, the symbolic code forming the symbolic model; and
outputting the symbolic model associated with semantic metadata containing the at least one respective metadata entity.

12. The method of claim 11, further comprising:
implementing a declaration extractor, using a first trained neural network, to extract the at least one markup declaration from the markup document; and
implementing a named entity recognition and relation extractor, using a second trained neural network, to extract the at least one respective math content span, any respective metadata entity and any relationship between the at least one respective math content span and any respective metadata entity.

13. The method of claim 12, wherein the first trained neural network and the second trained neural network are each based on a pre-trained natural language processing neural network.

14. The method of claim 11, further comprising:
providing a user interface for receiving the markup document and for displaying at least one symbolic parameter of the symbolic model, the at least one symbolic parameter corresponding to the at least one math content span, the at least one symbolic parameter being displayed with any related respective metadata entity.

15. The method of claim 14, further comprising:
receiving input to edit the at least one symbolic parameter.

16. The method of claim 11, further comprising:
obtaining at least one data definition;
generating at least one data definition mapping that maps the at least one data definition to at least one symbolic parameter of the symbolic model;
processing the symbolic model, using the at least one data definition mapping and the at least one data definition, to generate a model instance; and
outputting the model instance to be solved by a solver.

17. The method of claim 16, further comprising:
obtaining a solver configuration;
wherein the model instance is generated according to the solver configuration.

18. The method of claim 16, further comprising:
identifying a discrepancy between the at least one data definition and the at least one symbolic parameter; and
outputting a notification indicating the discrepancy.

19. The method of claim 16, wherein the symbolic model is stored in a database, and wherein the method further comprises retrieving the symbolic model from the database in response to a query.

20. A non-transitory computer-readable medium having instructions stored thereon, wherein the instructions are executable by a processing unit of a computing system to cause the computing system to:
receive a markup document representing an optimization problem the markup document containing human language content and mathematical content;
parse the markup document into a symbolic model containing only symbolic code representing the optimization problem by:
extracting at least one markup declaration from the markup document;
for the at least one markup declaration, extracting at least one respective math content span, and extracting any respective metadata entity and any relationship between the at least one respective math content span and any respective metadata entity;
for the at least one math content span, generating a respective math content parse tree; and
converting the respective math content parse tree to symbolic code using any relationship between the at least one respective math content span and any respective metadata entity. the symbolic code forming the symbolic model; and
output the symbolic model associated with semantic metadata containing the at least one respective metadata entity.
